(19) United States
(12) Patent Application Publication
(10) Pub. No.: US 2014/0284160 A1
(43) Pub. Date: Sep. 25, 2014

(54) DC TOOL CABLE REEL

(71) Applicants: Jimmy Ray Towe, Atlanta, GA (US); Lloyd Edward Nelson, Raleigh, NC (US); Kevin Bolyard, Angier, NC (US); Sam Woodard, Angier, NC (US)

(72) Inventors: Jimmy Ray Towe, Atlanta, GA (US); Lloyd Edward Nelson, Raleigh, NC (US); Kevin Bolyard, Angier, NC (US); Sam Woodard, Angier, NC (US)

(21) Appl. No.: 14/216,848

(22) Filed: Mar. 17, 2014

Related U.S. Application Data
(60) Provisional application No. 61/794,929, filed on Mar. 15, 2013.

(51) Int. Cl. H02G 11/02

(52) U.S. Cl. CPC H02G 11/02
USPC 191/12.2 R

(57) ABSTRACT

The present invention provides a DC tool cable reel apparatus. The DC tool cable reel includes a cord reel assembly for supporting a DC tool, and a side plate assembly attached to the cord reel assembly. The DC tool cable reel further includes a bracket assembly, wherein the side plate assembly and cord reel assembly are rotatably mounted on the bracket assembly, and a control assembly having a control cable that is electrically connected to a DC tool.

### CROSS-REFERENCE TO RELATED APPLICATION

This application claims the benefit of U.S. Provisional Patent Application Ser. No. 61/794,929, filed Mar. 15, 2013, the entirety of which is hereby incorporated herein by reference for all purposes.

### TECHNICAL FIELD

The present invention relates to a DC Tool Cable Reel (DCTCR), allows the user to safely retract and store their DC tool cable. The present invention enables multiple slip rings and custom connectors that allow the DCTCR to be easily changed over to handle various manufacturers' cable designs.

### BACKGROUND OF THE INVENTION

Take-up reels for managing the use and storage of electrical extension cords are known. Such reels consist basically of a spool rotatable affixed to a structural component whereby the spool is manually or automatically rotated to wind an extension cord thereabout. Typically, such automatic reels employ a variety of spring and ratchet mechanisms for maintaining the cord in the extended position and rewinding the cord onto the spool when it is no longer needed. Such reels are particularly useful in industrial or commercial settings such as automobile repair shops, machine shops, carpentry shops and construction sites. They permit workers to readily access electrical power as needed for the operation of portable electric tools, test devices, and trouble lights at various locations remote from an existing power outlet. In addition, the use of extension cord reels makes it possible to use only pigtails (i.e., short electrical cords) on the various electrical tools and devices thereby simplifying the movement and storage of the electrical tools and devices themselves.

While exterior designs may vary, retracting electric cord reels basically comprise a spool mounted on a shaft supported for rotation on a bracket or housing, a cooperating ratchet and pawl to arrest the rotation of the spool when the cord has been paid out to a desired length, a spring for rotating the spool in a direction to rewind the cord when the ratchet and pawl are disengaged and an electrical power input means including a commutator connected between a male plug extending from the housing and the extension cord wound on the spool. Such devices are shown, for example, in the U.S. Pat. Nos. 3,619,518; 3,715,526; and 3,808,382

Presently in manufacturing facilities using DC tools, the cables are either festooned overhead or pulled from a hook or attachment on a work bench when needed. Cables that are not festooned create a trip hazard. Cables not returned promptly to their assigned hook or mount are subject to damage. Presently there are no known reels for retraction of these expensive cables.

### SUMMARY OF THE INVENTION

In example embodiments, the present invention provides a DC tool cable reel apparatus. In one embodiment, the DC tool cable reel includes a cord reel assembly for supporting a DC tool, and a side plate assembly attached to the cord reel assembly. The DC tool cable reel further includes a bracket assembly, wherein the side plate assembly and cord reel assembly are rotatably mounted on the bracket assembly, and a control assembly having a control cable that is electrically connected to a DC tool.

In an alternative embodiment, the present invention provides a DC tool cable reel including a first internal electrical link connectable to a DC tool control socket, a second internal electrical link connectable to an DC tool connector socket, and a slip ring electrically connected to the first internal electrical link and the second internal electrical link. The DC tool cable reel further includes a cord reel assembly supporting a cord for a DC tool that is electrically connected to the DC tool connector socket, and bracket assembly for supporting a control cord that is electrically connected to the DC tool control socket and a control assembly.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1A shows an upper side view of the DCTCR of the present invention.

FIG. 1B shows a lower side view of the DCTCR of the present invention.

FIG. 1C shows a radial cross-section view of the DCTCR of the present invention.

FIG. 1D shows a frontal cross-section view of the DCTCR of the present invention.

FIG. 2A shows a lower side view of the side plate assembly of the present invention.

FIG. 2B shows an upper side view of the side plate assembly of the present invention.

FIG. 2C shows an exploded perspective view of the side plate assembly of the present invention.

FIG. 2D shows a frontal cross-section view of the side plate assembly of the present invention.

FIG. 2E shows a radial cross-section view of the side plate assembly of the present invention.

FIG. 3A is an exploded perspective view of bracket assembly of the present invention.

FIG. 3B is an upper side view of bracket assembly of the present invention.

FIG. 3C is a lower side view of bracket assembly of the present invention.

FIG. 3D is a frontal cross-section view of bracket assembly of the present invention.

FIG. 3E is a radial cross-section view of bracket assembly of the present invention.

FIG. 4 is an illustration of the control assembly connected to the DCTCR of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The present invention incorporates the TorqTec DC Tool Cable Reel (DCTCR), and allows the user to safely retract and store their DC tool cable. This removes the cable from the floor of the work area thus lessening a common trip hazard while at the same time protecting an expensive cable. The unique application of multiple slip rings and custom connectors allows the DCTCR to be easily changed over to handle various manufacturer's cable designs.

The DCTCR is a reel with a multiple slip ring configuration adapted specifically for DC Tool Cables. The versatility of the components allows the reel to be configured for a variety of manufacturer's DC tools. This is achieved by changing two components, the connector for the whip cable going to the DC Tool Controller and the connector on the DCTCR that the extension cable for the DC Tool connects to. The DCTCR also eliminates the need for expensive festooning systems as the reel can be mounted overhead. The DCTCR has a retraction feature that allows the tool operator to easily and safely return the cable to its home position.

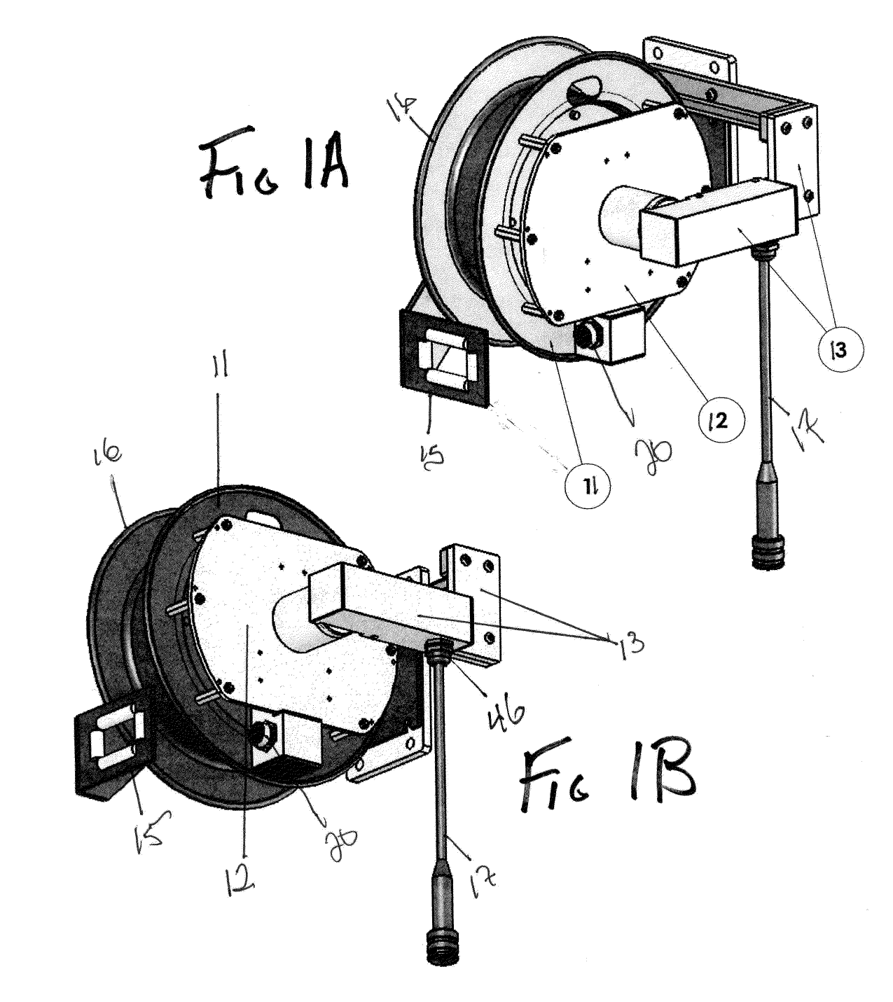

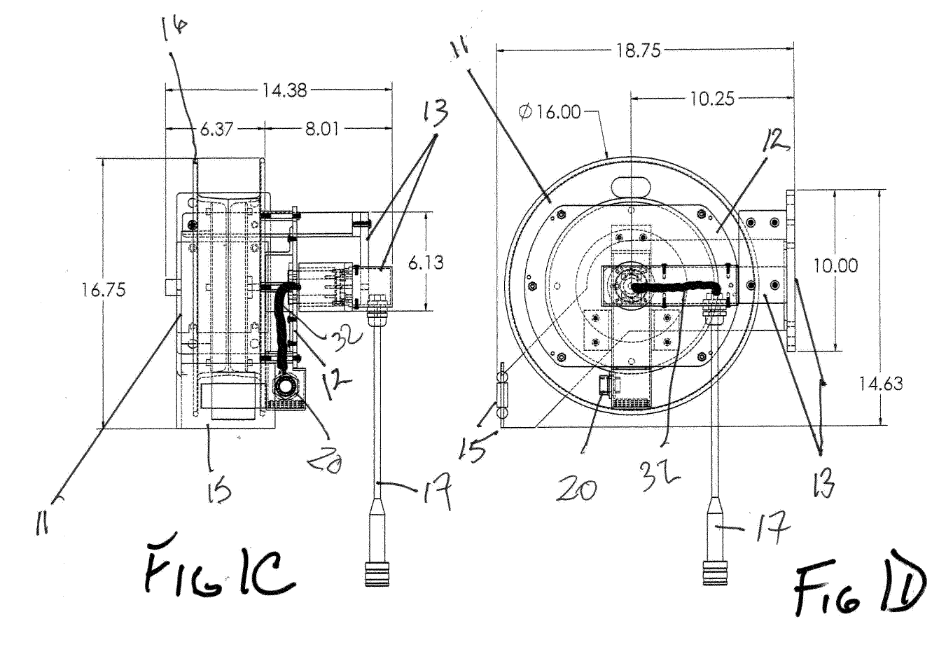

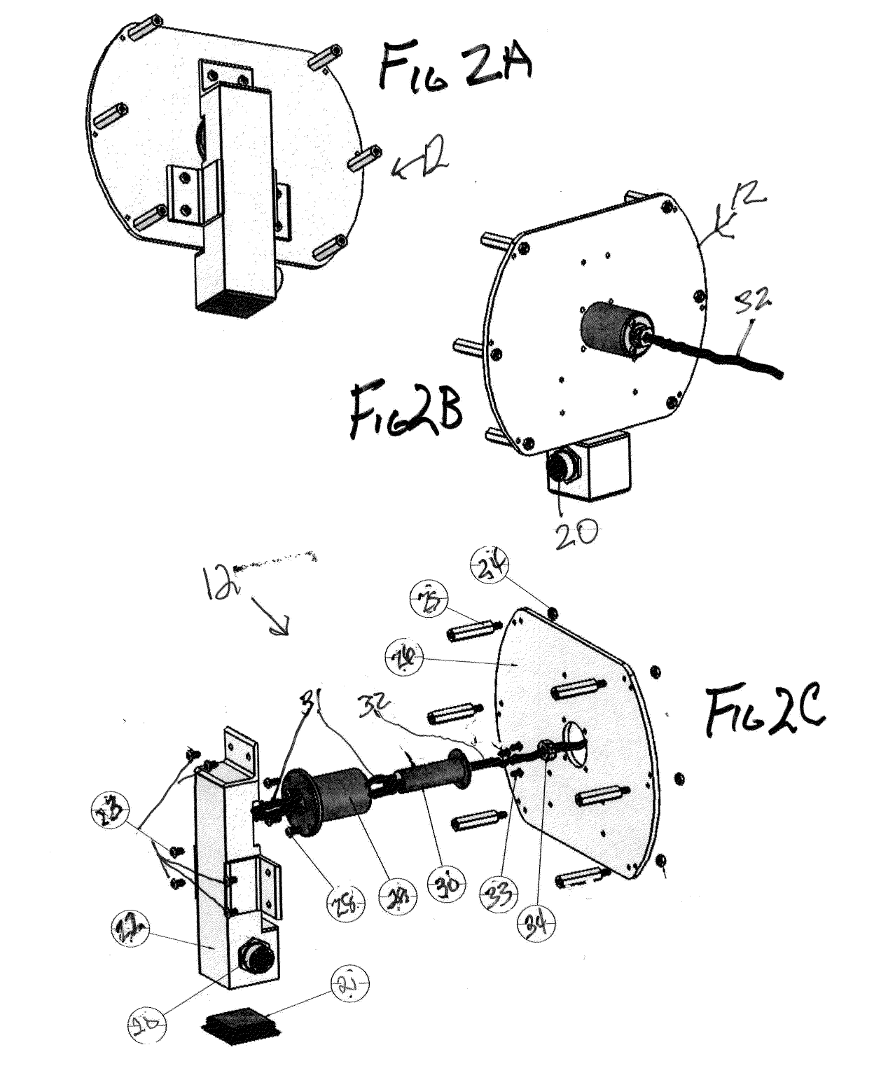

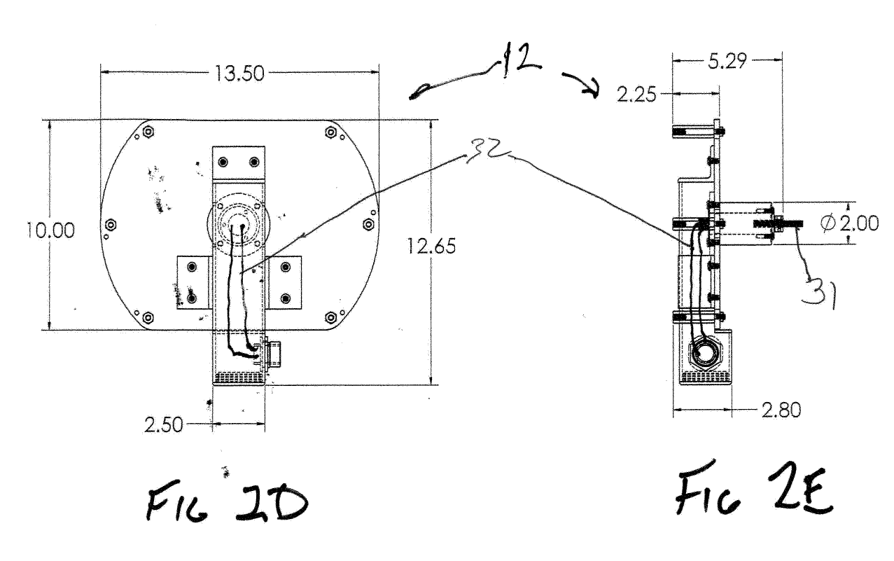

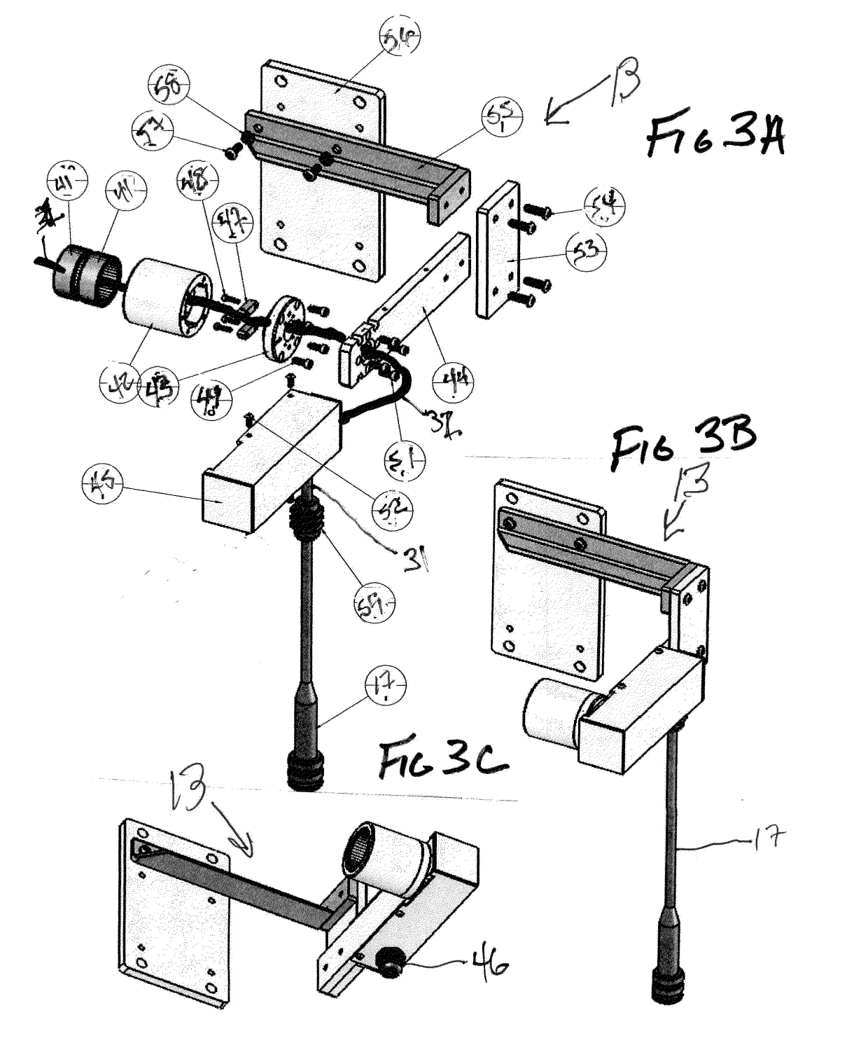

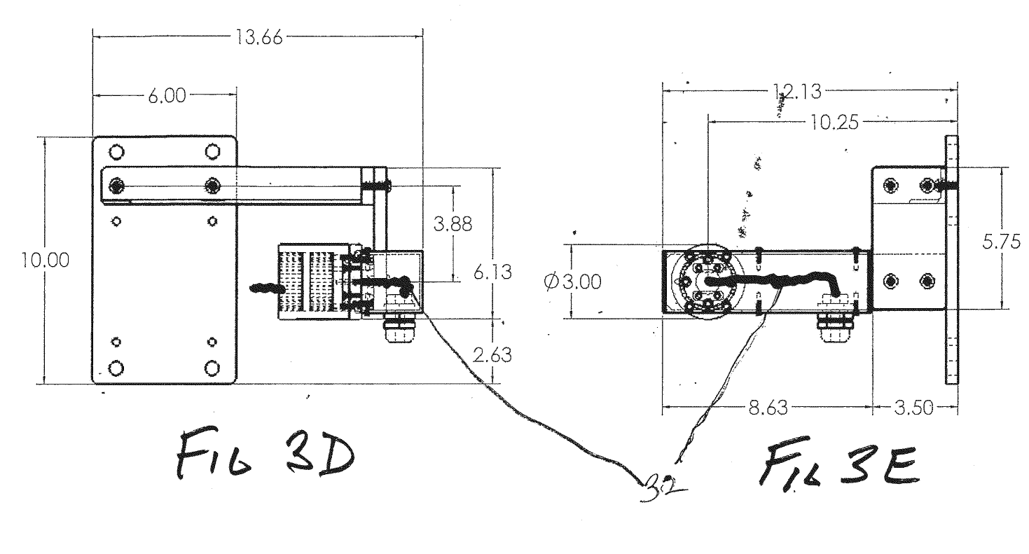

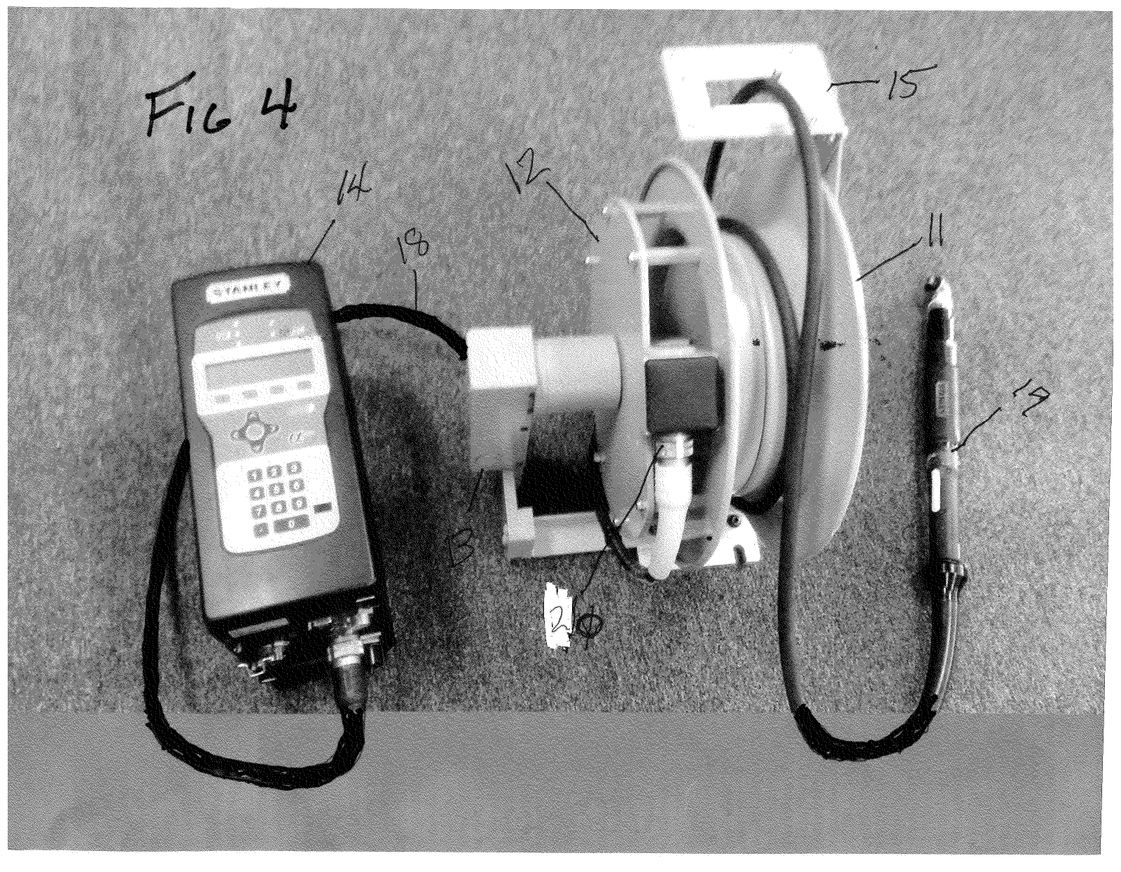

With reference now to the drawing figures, wherein like reference numbers represent corresponding parts throughout the several views. FIG. 1A shows an upper side view of the DCTCR 10 of the present invention. The DCTCR 10 of the present invention comprises of three different components. The components are the cord reel assembly 11, side plate assembly 12, and the bracket assembly 13. The side plate assembly 12, and the bracket assembly 13 will be discussed herein in further detail with regard to FIGS. 2 and 3. The cord reel assembly 11 is any commercially available cord reel 11. Preferably, the cord reel assembly 11 includes a pulley body 16 which cooperates with a return spring (not shown). The pulley body 16 has a generally tubular cord winding body having a radially outwardly extending flanges formed at each end thereof. The return spring (not shown) can be of any type including, but not limited to, compression, torsion, tension or clock spring. The pulley body 16 is generally disk-shaped with a central cup-shaped portion. The cup-shaped portion is where the DC tool cable storage area. The cord reel assembly 11 includes a tool cable support 15 to prevent strain of the tool cable.

FIG. 1B shows a lower side view of the DCTCR 10 of the present invention. Also illustrated are the DC tool connector cable 17 and DC tool connector socket 20. The DC tool connector cable 17 connects to the DC Tool Controller (FIG. 4). The control assembly enables a worker to control the functionality of the DC tool that is to be used. The control assembly is herein defined in further detail with regard to FIG. 4. The DC tool connector socket 20 connects to the DC cable tool (FIG. 4) through the DC cable within the core reel assembly 11. The versatility of the DC tool connector cable 17 and DC tool connector socket 20 that allows the DCTCR 10 to be configured for a variety of manufacturer's DC tools. This is achieved by changing two components, the DC tool connector cable 17 going to the DC Tool Controller (FIG. 4) and the DC tool connector socket 20 on the DCTCR 10.

FIG. 1C shows a radial cross-section view of the DCTCR 10 of the present invention. FIG. 1D shows a frontal cross-section view of the DCTCR of the present invention. In FIGS. 1C and 1D are the preferred dimensions for the DCTCR 10 of the present invention

FIG. 2A shows a lower front side view of the side plate assembly 12 of the present invention. FIG. 2B shows an upper back side view of the side plate assembly of the present invention.

FIG. 2C shows an exploded perspective view of the side plate assembly of the present invention. The DC tool connector socket 20 is supported by the wiring harness cover 22. The wiring harness cover 22 covers the stationary pair of wires 31 connected to the DC tool connector socket 20. Anchoring the wire harness cover 22 to the reel flange plate 26 is accomplished using button head cap screws 23. The wire harness cover 22 also covers the swivel shaft 29 and slip ring 30 assembly.

A slip ring 30 can be used in any electromechanical system that requires unrestrained, intermittent, or continuous rotation while transferring power and/or data. An example of a slip ring 30 is the AC6355 slip ring available from Moog Inc. The slip ring 30 is connected to the swivel shaft 29 using button head cap screws 33 that attach the slip ring 32 the swivel shaft 29. The stationary pair of wires 31 traversed through the swivel shaft 29 into the wire harness cover 22 and attached to the DC tool connector socket 20. The rotating bundle of wires 32 are connected to the slip ring 30 and traverse through a lock nut 34 and further through reel flange plate 26. The rotatable bundle of wires 32 traverse through the bracket assembly and connect to the DC tool connector cable 17.

Standoffs 25 are attached to reel flange plate 26 using hex nuts 24. The standoffs provide room for the swivel shaft 29 and slip ring 30 within the wiring harness cover 22 between the reel core assembly 11 and side plate assembly 12. The standoffs 25 are then connected to the reel core assembly 11 using screws (not shown). FIG. 2D shows a frontal cross-section view of the side plate assembly of the present invention. This view shows the measurements of the components and the preferred configuration of the reel core assembly 11. FIG. 2E shows a radial cross-section view of the side plate assembly of the present invention. This view shows the measurements of the components and the preferred configuration of the reel core assembly 11.

FIG. 3A is an exploded perspective view of bracket assembly 13 of the present invention. The rotating bundle of wires 32 from the slip ring 30 in the side plate assembly 12 is threaded through the roller bearing 41 within the bearing shaft 42. The rotating bundle of wires 32 is then threaded through the collar flange 43 and support arm 44 that is covered by the square tube cover 45. The rotating bundle of wires 32 is then connected to DC tool connector socket 46 that enables the DC tool connector cable 17 to be connected. It is because of the roller bearing 41 and the rotating bundle of wires 32 that the cord reel assembly 11 attached to the side plate assembly 12 can rotate around the bracket assembly 13. On some models of the DC tool connector cable 17 is the strain relief 59. This is to compensate for strain on the control cable from the DC tool control (FIG. 4).

Attached to the collar flange 45 are collar keys 47. The collar keys are attached to the collar flange 45 using socket head cap screws 48. The collar flange 43 is attached to the bearing shaft 42 using button head cap screws 49. The collar flange 45 is then connected to the support arm 44 using button head screws 51. A square tube cover 45 is attached to the support arm 44 using button head cap screws 52.

The support arm 44 is then connected to the side plate 53 using button head cap screws 54. The side plate 53 is then connected to the arm bracket 55 using button head cap screws 54. In the arm bracket 55 is then connected to the end plate 56 using button head cap screws 57 and lock parsers 58.

FIG. 3B is an upper side view of bracket assembly 13 of the present invention. FIG. 3C is a lower side view of bracket assembly 13 of the present invention. FIG. 3D is a frontal cross-section view of bracket assembly of the present invention. This view shows the measurements of the components and the preferred configuration of the bracket assembly 13. FIG. 3E is a radial cross-section view of bracket assembly of the present invention. This view shows the measurements of the components and the preferred configuration of the bracket assembly 13.

FIG. 4 is an illustration of the control assembly 14 connected to the DCTCR 10 of the present invention. The control assembly 14 is connected to the DC tool socket 46 on bracket assembly 13 through control cable 18. Signals from the control assembly 14 are transmitted to the DC tool 19 through the stationary pair of wires 31 two slip ring 30 and then through the rotating bundle of wires 32 to the DC tool connector socket 20. The DC tool 19 is then connected to the DC tool connector socket 20. The DC tool connector socket 20 and DC control socket 46 can be replaced to offer different control assembly 14 and DC Tools 19.

The control assembly 14 can be set to control the DC tool 19 so as to perform specific operations. Operations include, but are not limited to, tort control, rotational control, data recording, speed control of the DC tool including throttling up and down depending on the circumstance, and the like. In the instance of data recording, in some industries this data is archived for later technical and legal reference.

While the invention has been described with reference to preferred and example embodiments, it will be understood by those skilled in the art that a variety of modifications, additions and deletions are within the scope of the invention, as defined by the following claims.

What is claimed is:

1. A DC tool cable reel, comprising:
a cord reel assembly for supporting a DC tool;
a side plate assembly attached to the cord reel assembly;
a bracket assembly, wherein the side plate assembly and cord reel assembly are rotatable mounted on the bracket assembly; and
a control assembly having a control cable that is electrically connected to a DC tool.

2. The DC tool cable reel of claim 1, wherein the side plate assembly supports a slip ring that is electrically connected to the control assembly and the DC tool.

3. The DC tool cable reel of claim 2, wherein the DC tool is electrically connected to the side plate assembly through a DC tool socket.

4. The DC tool cable reel of claim 3, wherein the DC tool socket is electrically connected to the slip ring.

5. The DC tool cable reel of claim 2, wherein the control cable is electrically connected to the bracket assembly by a DC tool connector socket.

6. The DC tool cable reel of claim 5, wherein the DC tool connector socket is electrically connected to the slip ring.

7. The DC tool cable reel of claim 1, wherein the bracket assembly is mechanically attached to the side plate assembly using at least one roller bearing.

8. A DC tool cable reel, comprising:
a first internal electrical link connectable to a DC tool control socket;
a second internal electrical link connectable to an DC tool connector socket;
a slip ring electrically connected to the first internal electrical link and the second internal electrical link;
a cord reel assembly supporting a cord for a DC tool that is electrically connected to the DC tool connector socket; and
a bracket assembly for supporting a control cord that is electrically connected to the DC tool control socket and a control assembly.

9. The DC tool cable reel of claim 8, wherein the bracket assembly is mechanically attached to the cord reel assembly using at least one roller bearing.
